(19) United States
(12) Patent Application Publication
(10) Pub. No.: US 2012/0086456 A1
(43) Pub. Date: Apr. 12, 2012

(54) METHOD AND APPARATUS FOR ESTIMATING VISCOSITY AND DENSITY DOWNHOLE USING A RELAXED VIBRATING ELECTRICALLY CONDUCTIVE ELEMENT

(75) Inventor: Sunil Kumar, Celle (DE)

(73) Assignee: BAKER HUGHES INCORPORATED, Houston, TX (US)

(21) Appl. No.: 13/252,792

(22) Filed: Oct. 4, 2011

Related U.S. Application Data
(60) Provisional application No. 61/390,895, filed on Oct. 7, 2010.

(51) Int. Cl. G01V 3/08

(52) U.S. Cl. 324/346

(57) ABSTRACT

An apparatus and method for estimating a parameter of interest in a downhole fluid using a fluid analyzer. The fluid analyzer may include: a electrically conductive element configured to vibrate in response to an energy source, a housing to enclose the electrically conductive element and receive a fluid, and a sensor configured to respond to shear waves induced in the fluid by the vibration of the electrically conductive element. The electrically conductive element may be relaxed during operation. Also disclosed is a method of use for the apparatus.

### CROSS-REFERENCE TO RELATED APPLICATIONS

This application claims priority from U.S. Provisional Patent Application Ser. No. 61/390,895, filed on 7 Oct. 2010, the disclosure of which is incorporated herein by reference in its entirety.

### FIELD OF THE DISCLOSURE

This disclosure generally relates to acquiring, analyzing, and/or retrieving fluid samples. In certain aspects, the disclosure relates to analysis of fluids in a borehole penetrating an earth formation.

### BACKGROUND OF THE DISCLOSURE

Fluid evaluation techniques are well known. Broadly speaking, analysis of fluids may provide valuable data indicative of formation and wellbore parameters. Many fluids, such as formation fluids, production fluids, and drilling fluids, contain a large number of components with a complex composition. In some applications, it may be useful to perform tests on samples in the borehole, or in situ, as well as on samples retrieved to the surface.

This disclosure provides an apparatus and method to more effectively retrieve and analyze fluids.

### SUMMARY OF THE DISCLOSURE

In aspects, this disclosure generally relates to exploration for hydrocarbons involving in situ analysis of fluids in a borehole penetrating an earth formation. More specifically, this disclosure relates to analysis of fluids using a device formed with a vibrating electrically conductive element without any external tension or compression.

One aspect according to the present disclosure may include an apparatus for estimating at least one parameter of interest of a fluid, comprising: an electrically conductive element in contact with a fluid in a fluid channel and responsive to an applied magnetic field, the electrically conductive element being relaxed; and at least one sensor responsive to a motion of the electrically conductive element.

Another aspect according to the present disclosure may include a method of estimating at least one parameter of interest of a fluid, comprising: estimating the at least one parameter of interest using information from at least one sensor responsive to a relaxed electrically conductive element, the electrically conductive element being responsive to an applied magnetic field.

Examples of the certain features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of a fluid analyzer deployed in a wellbore along a wireline according to one embodiment of the present disclosure;

FIG. 2 shows a schematic of a fluid analyzer according to one embodiment of the present disclosure;

FIG. 3 shows a schematic of a fluid analyzer according to another embodiment of the present disclosure; and

FIG. 4 shows a flow chart of another method for estimating a parameter of interest using a fluid analyzer according to one embodiment of the present disclosure.

### DETAILED DESCRIPTION

This disclosure generally relates to analysis of fluids. In one aspect, the present disclosure relates to the analysis of fluids using an analyzer that includes an electrically conductive element configured to be immersed in a fluid and to vibrate in the fluid, causing shear waves. In another aspect, the electrically conductive element is configured to move through the fluid. The moving electrically conductive element may incur a viscous drag which may be measured to estimate a property of the fluid, such as, but not limited to, viscosity, density and rheology. The electrically conductive element may be formed, at least in part, of an electrically conductive material including, but not limited to, one or more of: (i) a metal and (ii) a metallic layer. The electrically conductive element may have an insulating coating to avoid electrical shorting in electrically conductive fluids. The electrically conductive element may have a protective coating to enable the electrically conductive element to withstand chemically and mechanically aggressive fluids that degrade, erode, and/or corrode the electrically conductive element. The vibratory motion of the electrically conductive element may be induced exposing the electrically conductive element to an applied energy field while an electric current flows through the electrically conductive element. The electrically conductive element may be relaxed. Herein, an object is “relaxed” when the object is not under external tension during operation. That is, for example, an external device or component does not apply a tension or force to the electrically conductive element. Thus, in certain uses, the term “external” refers to a tension applying device that is not the fluid being investigated. In such instances, the fluid may apply a local or other tension force to the electrically conductive element. In some embodiments, the applied energy field may be generated by an energy source, such as a cycled or pulsed electromagnetic source (e.g. electromagnet, AC or pulsed DC). The electrically conductive element may be formed of a material that is responsive to the pulsed electromagnetic source. In some embodiments, the electrically conductive member may vibrate at a variety of different frequencies based, at least in part, on the frequency of the pulsed electromagnetic source. In some embodiments, the electrically conductive element may be isolated from other sources of vibration or energy. These frequencies may include a resonant frequency and non-resonant frequencies. When the energy source is active, motion may be induced in the electrically conductive element; however, when energy source is inactive, the induced motion and resulting shear waves in the fluid will be damped by the presence of fluid surrounding the electrically conductive element. The damping or decay of the shear waves may be measured using at least one sensor configured to generate information indicative of an estimate of the motion of the electrically conductive element. Herein, “information” may include raw data, processed data, analog signals, and digital signals. Characteristics of the decay may be used to estimate the density viscosity product of the fluid. Viscosity and density may be used to estimate gas/oil ratio and calculate permeability of the formation.

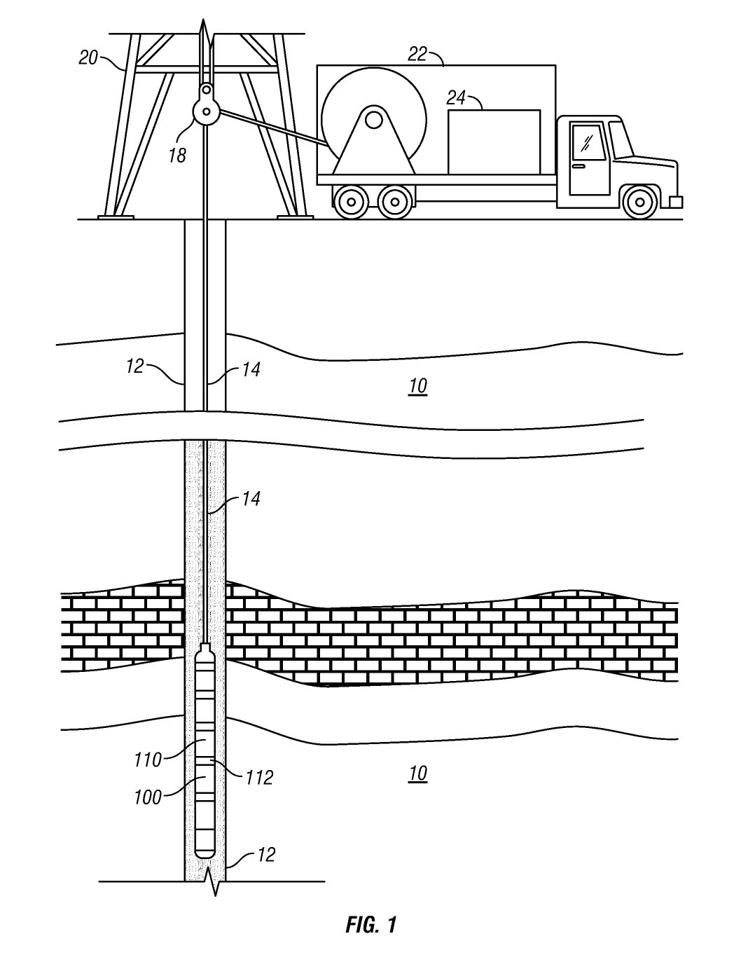

Referring initially to FIG. 1, there is schematically represented a cross-section of a subterranean formation 10 in which is drilled a borehole 12. Suspended within the borehole 12 at the bottom end of a conveyance device such as a wireline 14 is a downhole assembly 100. The wireline 14 is often carried over a pulley 18 supported by a derrick 20. Wireline deployment and retrieval is performed by a powered winch carried by a service truck 22, for example. A control panel 24 interconnected to the downhole assembly 100 through the wireline 14 by conventional means controls transmission of electrical power, data/command signals, and also provides control over operation of the components in the downhole assembly 100. The data may be transmitted in analog or digital form. Downhole assembly 100 may include a fluid testing module 112. Downhole assembly 100 may also include a sampling device 110. Herein, the downhole assembly 100 may be used in a drilling system (not shown) as well as a wireline. While a wireline conveyance system has been shown, it should be understood that embodiments of the present disclosure may be utilized in connection with tools conveyed via rigid carriers (e.g., jointed tubular or coiled tubing) as well as non-rigid carriers (e.g., wireline, slickline, e-line, etc.). Some embodiments of the present disclosure may be deployed along with Logging While Drilling/Measurement While Drilling (LWD/MWD) tools.

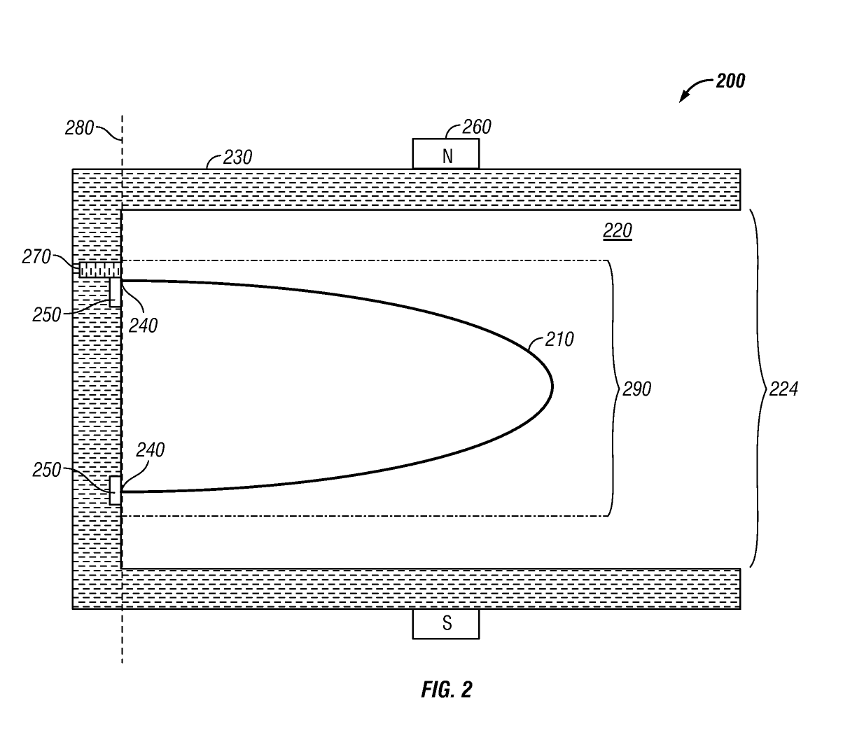

FIG. 2 shows an exemplary embodiment according to the present disclosure. The fluid testing module 112 may include a fluid analyzer 200, which includes an electrically conductive element 210. Electrically conductive element 210 may be configured to be in contact with fluid 220. Electrically conductive element 210 may be formed at least in part of one or more of: (i) a metal, (ii) an electrically conductive polymer, and (iii) an electrically conductive ceramic. In some embodiments, the electrically conductive element 210 may be disposed on a substrate (not shown). Fluid 220 may include, but is not limited to, one or more of: (i) drilling fluid, (ii) formation fluid, and (iii) fracturing fluid. Fluid 220 may enter a fluid channel formed by a housing 230, such as a tubular or pipe, configured to receive a fluid 220. The fluid 220 may be received by the housing 230 through opening 224. In some embodiments, fluid 220 may enter through a different opening than the fluid 220 exits. The electrically conductive element 210 may be mounted or operably connected to the inside of the housing 230. The electrically conductive element 210 may by connected to housing 230 at one or more anchor points 240 along a closed end of housing 230. The electrically conductive element 210 may be located within housing 230 such that it is surrounded by fluid 220. At least one magnetic field source 260 may be located outside the housing 230 and positioned in proximity to the electrically conductive element 210. In some embodiments, the magnetic field source 260 may be located inside the housing 230. The magnetic field source 260 may include at least one of: (i) an electromagnet and (ii) a permanent magnet. At least one sensor 250 may be located at at least one of the anchor points 240. The at least one sensor 250 may be responsive to mechanical stress or strain. In some embodiments, the at least one sensor 250 may be formed at least in part of at least one of: (i) a piezoresistive material, (ii) a piezoelectric material, (iii) a p-n junction transistor, and (iv) a magnetorestrictive material. In some embodiments, the at least one sensor 250 may be configured to generate a information indicative of an applied magnetic field. The at least one sensor 250 may be configured to generate information indicative of a mechanical force from the electrically conductive element 210. The generated information may include, but is not limited to, amplitude, frequency, and phase of the electrically conductive element 210. Energy source 270 may be in electrical communication with electrically conductive element 210 and configured to produce an electric current though the electrically conductive element 210. The motion of the electrically conductive element 210 may generate a shear wave in the fluid 220. The rate of damping of the shear wave in the fluid 220 may be used to estimate at least one parameter of interest of the fluid 220. The at least one parameter of interest may include, but is not limited to, one or more of: (i) a rheological property, (ii) fluid density, and (iii) fluid viscosity. The viscous drag caused by the fluid 220 on electrically conductive element 210 and measured as a strain or change in property of magnetostrictive material by sensor 250 may be used to characterize properties of the fluid 220. The damping of the shear wave may be estimated from the change in motion of the electrically conductive element 210 as the fluid 220 resists the vibratory motion of the electrically conductive element 210. The fluid 220 may be substantially stationary, with little or no movement, or flowing while within housing 230. If the fluid 220 is flowing, the fluid 220 may have a linear or non-linear flow path through the fluid analyzer 200, 300. In some embodiments, the flow path may be non-parallel with an axis 280 formed by two or more anchor points 240. The anchor points 240 may be disposed outside a medial region 290 of the flow path or in the medial region 290 of the flow path.

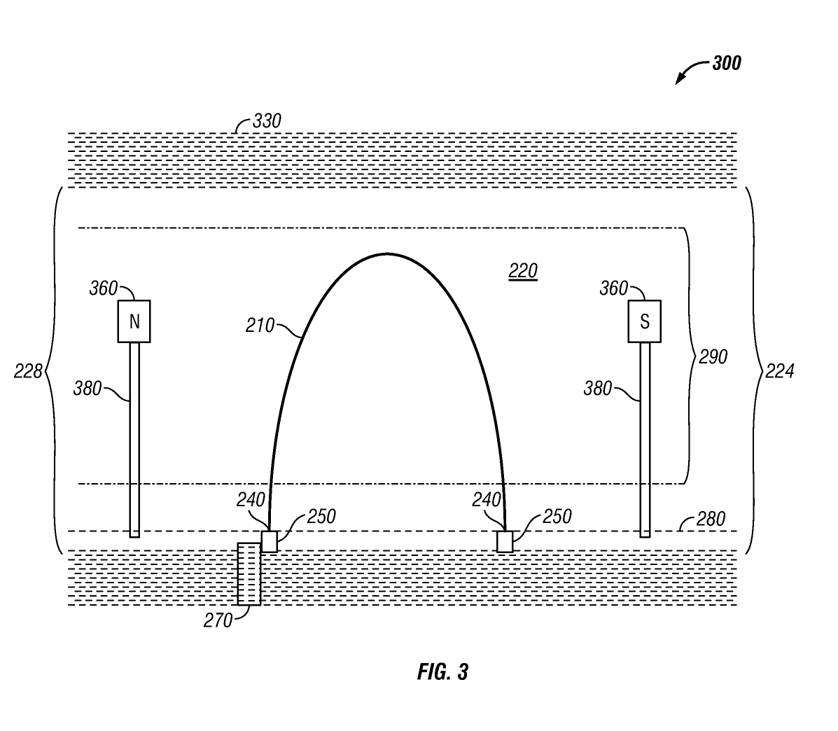

FIG. 3 shows another exemplary embodiment according to the present disclosure. The fluid testing module 112 may include a fluid analyzer 300, which includes an electrically conductive element 210. Electrically conductive element 210 may be configured to be in contact with fluid 220. Fluid 220 may enter a fluid channel formed by a housing 330, such as a tubular or pipe, configured to receive a fluid 220 though opening 224, such that fluid 220 may exit though opening 228. The electrically conductive element 210 may be mounted or operably connected to the inside of the housing 330. The electrically conductive element 210 may by connected to housing 330 at one or more anchor points 240 located along the wall of housing 330. The electrically conductive element 210 may be located within housing 330 such that it is surrounded by fluid 220. At least one magnetic field source 360 may be located inside the housing 330 and positioned in proximity to the electrically conductive element 210. In some embodiments, the magnetic field source 360 may be positioned using one or more posts or other physical members 380. In some embodiments, the posts 380 may be sized to reduce fluid flow obstruction or interference caused by the posts 380. In some embodiments, the magnetic field source 360 may be located outside the housing 330. The magnetic field source 360 may include at least one of: (i) an electromagnet and (ii) a permanent magnet. At least one sensor 250 may be located at at least one of the anchor points 240. The at least one sensor 250 may be configured to generate information indicative of a mechanical force from the electrically conductive element 210. Energy source 270 may be in electrical communication with electrically conductive element 210 and configured to transmit an electric current though the electrically conductive element 210. The motion of the electrically conductive element 210 may generate shear waves in the fluid 220. The rate of damping of the shear waves in the fluid 220 may be used to characterize properties of the fluid 220. The damping of the shear waves may be estimated from the change in motion of the electrically conductive element 210 as the fluid 220 resists the vibratory motion of the electrically conductive element 210.

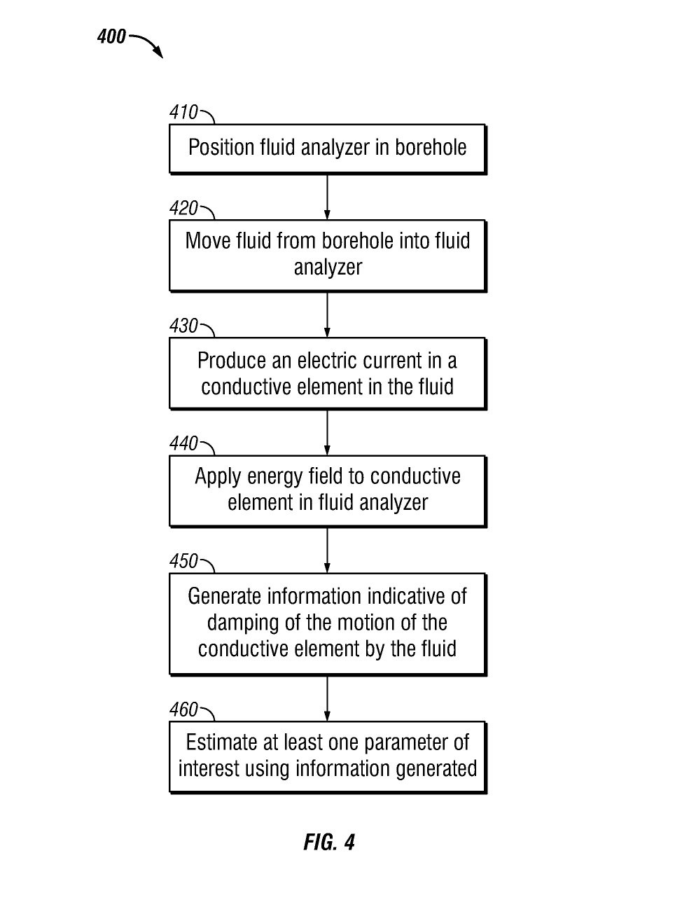

FIG. 4 shows an exemplary method 400 according to one embodiment of the present disclosure. In method 400, a fluid analyzer 200, 300 may be positioned within a borehole 12 in step 410. In some embodiments, the fluid analyzer 200, 300 may be configured to permanently reside downhole. Then, in step 420, fluid 220 may be moved into the fluid analyzer 200 from the borehole 12 or a sampling device 110, such that electrically conductive element 210 may be in contact with the fluid 220. The fluid 220 may be substantially stationary, with little or no movement, or flowing while within housing 230, 330. If the fluid 220 is flowing, the fluid 220 may have a linear or non-linear flow path through the fluid analyzer 200, 300. In some embodiments, the flow path may be non-parallel with an axis 280 formed by two or more anchor points 240. The anchor points 240 may be disposed outside a medial region 290 of the flow path or in the medial region 290 of the flow path. In step 430, electric current may be produced in the electrically conductive element 210 from energy source 270. In step 440, magnetic field source 260, 360 may be energized to apply a pulsed magnetic field to the electrically conductive element 210, which may cause the electrically conductive element 210 to vibrate when an electric current is present in the electrically conductive element 210. In step 450, at least one sensor 250 responsive to mechanical motion due to the vibration of the electrically conductive element 210 may send information indicative of the motion to at least one processor (not shown). In step 460, the at least one processor estimates at least one parameter of interest using the information indicative of the damping caused by fluid 220. The estimating of the at least one parameter of interest may include comparing one or more properties of the vibrations when the electrically conductive element 210 is in contact with fluid 220 to vibrations when the electrically conductive element 210 is surrounded in one of: (i) a vacuum, (ii) a gas, and (iii) a mixture of gasses. The one or more properties of the vibrations may include, but are not limited to, one or more of: (i) amplitude, (ii) frequency, and (iii) phase. The at least one parameter of interest may include, but is not limited to, one or more of: (i) a rheological property, (ii) fluid density, and (iii) fluid viscosity.

While the foregoing disclosure is directed to the one mode embodiments of the disclosure, various modifications will be apparent to those skilled in the art. It is intended that all variations be embraced by the foregoing disclosure.

What is claimed is:

1. An apparatus for estimating at least one parameter of interest of a fluid, comprising:
an electrically conductive element in contact with a fluid in a fluid channel and responsive to an applied magnetic field, the electrically conductive element being relaxed; and
at least one sensor responsive to a motion of the electrically conductive element.

2. The apparatus of claim 1, wherein the fluid is substantially stationary within the fluid channel.

3. The apparatus of claim 1, wherein the electrically conductive element is disposed on a substrate.

4. The apparatus of claim 1, wherein the electrically conductive element has at least one of: (i) an insulating coating and (ii) a protective coating.

5. The apparatus of claim 1, wherein the fluid has a flow path, the flow path being in at least two directions.

6. The apparatus of claim 1, the electrically conductive element having at least two anchors, the at least two anchors forming an axis.

7. The apparatus of claim 6, the flow path being non-parallel with the axis.

8. The apparatus of claim 6, the flow path having a central region, and the at least two anchors being located outside of the central region.

9. The apparatus of claim 1, where the at least one sensor is operably coupled to at least one end of the electrically conductive element.

10. The apparatus of claim 1, where the at least one sensor is configured to estimate one of: (i) strain and (ii) an amplitude of the applied magnetic field.

11. The apparatus of claim 1, where the at least one parameter of interest includes at least one of: (i) a rheological property, (ii) fluid density, and (iii) fluid viscosity.

12. The apparatus of claim 1, further comprising
a magnetic field source disposed outside the fluid channel and configured to induce motion in the electrically conductive element.

13. The apparatus of claim 12, where the at least one sensor is part of the magnetic field source.

14. The apparatus of claim 12, where the magnetic field source is configured to induce motion in the electrically conductive element at a specific frequency.

15. The apparatus of claim 14, where the specific frequency is a non-resonant frequency of the electrically conductive element.

16. A method of estimating at least one parameter of interest of a fluid, comprising:
estimating the at least one parameter of interest using information from at least one sensor responsive to a relaxed electrically conductive element, the electrically conductive element being responsive to an applied magnetic field.

17. The method of claim 16, the electrically conductive element being in contact with a fluid.

18. The method of claim 16, further comprising:
conveying the apparatus into a borehole.

19. The method of claim 16, further comprising:
generating the applied magnetic field using a magnetic source.

20. The method of claim 19, using at least part of the magnetic field source for the at least one sensor.
